(19) United States
(12) Patent Application Publication
(10) Pub. No.: US 2012/0100520 A1
(43) Pub. Date: Apr. 26, 2012

(54) ASSEMBLY PROCESS VISUALIZATION APPARATUS AND METHOD

(75) Inventors: Dong-Sik JO, Daejeon (KR); Yong-Wan KIM, Daejeon (KR); Ung-Yeon YANG, Daejeon (KR); Gun A. LEE, Daejeon (KR); Ki-Hong KIM, Daejeon (KR)

(73) Assignee: Electronics and Telecommunications Research Institute, Daejon (KR)

(21) Appl. No.: 13/223,466

(22) Filed: Sep. 1, 2011

(30) Foreign Application Priority Data
Oct. 25, 2010 (KR) 10-2010-0104135

(51) Int. Cl. G09B 25/00

(52) U.S. Cl. 434/365

(57) ABSTRACT

Disclosed herein is an assembly process visualization apparatus. The assembly process visualization apparatus includes an authoring unit, a storage unit, and a visualization unit. The authoring unit authors an assembly process manual in such a way as to model each stage of an assembly process of assembling a plurality of components and completing a finished product using 3-Dimensional (3D) stereoscopic images. The storage unit stores the assembly process manual authored using the authoring unit. The visualization unit visualizes the each stage of the assembly process manual stored in the storage unit to a user.

### CROSS REFERENCE TO RELATED APPLICATION

This application claims the benefit of Korean Patent Application No. 10-2010-0104135, filed on Oct. 25, 2010, which is hereby incorporated by reference in its entirety into this application.

### BACKGROUND OF THE INVENTION

1. Technical Field

The present invention relates generally to an assembly process visualization technology. In particular, the present invention relates to an assembly process visualization apparatus and method capable of minutely and intuitively observing each stage of a product assembly process.

2. Description of the Related Art

An assembly process is a series of operations in which a plurality of components are coupled to each other, thereby forming a finished product. Further, an assembly process needs to educate or be proposed to workers in an industry, students in a school, and children at home for various purposes. Since such an assembly process is used to couple a plurality of different components to each other, manuals regarding the assembly process (hereinafter referred to as assembly process manuals) are required. However, most assembly process manuals express themselves using only simple text and drawings, so that an easy and intuitive assembly execution method has not been proposed.

For example, when an industrial worker assembles a complex machine or when a child connects blocks for children and assembles a finished product, such as a toy car, at home, an existing paper-based assembly process manual in an analog manner is not intuitive. Therefore, it takes a considerable amount of time for the worker or the child, that is, an assembler, to assemble the corresponding product, and it takes a considerable amount of time to detect the assembly process manual and assemble the corresponding product in the case of a reassembly process for restoring a broken portion.

### SUMMARY OF THE INVENTION

Accordingly, the present invention has been made keeping in mind the above problems occurring in the prior art, and an object of the present invention is to provide each stage of a product assembly process using 3D stereoscopic images, so that a user can intuitively and rapidly understand the assembly process.

Another object of the present invention is to apply colors and materials previously stored for respective components and new colors and materials, in which the previously stored various colors and materials are mixed, to an assembly process manual.

Further another object of the present invention is to recognize an actual component assembly step using images, and to guide a user through assembling a component which will be subsequently assembled.

Still another object of the present invention is to differently express areas where components will be adhered to each other based on a method of coupling components, so that a user can intuitively and easily detect the method of coupling components using an assembly process manual.

In order to accomplish the above objects, the present invention provides an assembly process visualization apparatus, including: an authoring unit for authoring an assembly process manual in such a way as to model each stage of an assembly process of assembling a plurality of components and completing a finished product using 3-Dimensional (3D) stereoscopic images; a storage unit for storing the assembly process manual authored using the authoring unit; and a visualization unit for visualizing the each stage of the assembly process manual stored in the storage unit to a user.

Here, the visualization unit may include an assembly information recognition unit for recognizing an actual component assembly step using images; a display unit for displaying the assembly process manual to the user; and a control unit for analyzing the images recognized using the assembly information recognition unit, searching the assembly process manual for an assembly step which corresponds to the actual component assembly step, and performing control such that the assembly process corresponding to the assembly step of the assembly process manual is displayed on the display unit.

Here, the visualization unit may include: an assembly process manual input/output unit formed such that the user can select a specific assembly step of the assembly process manual stored in the storage unit; a display unit for displaying the assembly process manual to the user; and a control unit for performing control such that the assembly process corresponding to the specific assembly step selected by the user using the assembly process manual input/output unit is displayed on the display unit.

Here, the assembly process manual input/output unit may be formed such that the user can select the assembly process manual to be output to an outside; and the control unit performs control such that the assembly process manual is displayed on an external display apparatus when the user selects the assembly process manual to be output to the outside using the assembly process manual input/output unit.

Here, the authoring unit may include: a 3D modeling data manufacture unit for analyzing 3D geometric information related to the plurality of components, and manufacturing the 3D modeling data of the plurality of components; a color/material expression unit for expressing one or more colors and materials to the 3D modeling data of the plurality of components; and an animation operation expression unit for authoring the assembly process manual in such a way as to include movement data for an assembly operation, in which the finished product is completed using the plurality of components, with the 3D modeling data of the plurality of components, in which the colors and materials thereof are expressed using the color/material expression unit.

Here, the storage unit may store color and material data to be applied to the 3D modeling data of the plurality of components; and the color/material expression unit may include: a new color generation unit for generating at least one digital data value corresponding to a color with which two different colors are mixed; and a color/material definition unit for defining a color and the material of each of the components based on the color and material data stored in the storage unit. Here, the storage unit may further store color and material data to be applied to the 3D modeling data of the plurality of components; and the color/material expression unit may include: a new material generation unit for generating at least one digital data value corresponding to a material with which two different materials are mixed; and a color/material definition unit for defining a color and the material of each of the components based on the color and material data stored in the storage unit.

Here, the animation operation expression unit may include: a constraint definition unit for defining one or more coupling constraints between the components based on information about a coupling relationship between the plurality of components such that the plurality of components are coupled to each other only in one or more predetermined areas; a snap-dragging definition unit for defining a method of coupling the plurality of components to each other along one or more predetermined assembly points or assembly lines based on the information about the coupling relationship between the plurality of components; and a gesture-based operation definition unit for defining the movement data for each stage of the assembly process of completing the finished product using the plurality of components.

Here, the animation operation expression unit may include an adhesion method definition unit for differently expressing the adhesion portions of the respective components based on an adhesion method used between the plurality of components.

Here, the 3D modeling data manufacture unit may manufacture the 3D modeling data using at least one of a shape detection-based shape modeling method using camera images, a sketch-based shape modeling method, a template-based modeling method, and a clipart-based texture mapping method.

Further, in order to accomplish the above-described objects, an assembly process visualization method according to the present invention, including: authoring an assembly process manual in such a way as to model each stage of an assembly process of completing a finished product by assembling a plurality of components using 3D stereoscopic images; storing the assembly process manual, authored at the authoring the assembly process manual, in a storage unit; and visualizing the each stage of the assembly process manual stored in the storage unit to a user.

Here, the assembly process visualization method may further includes: recognizing an actual component assembly step using images; and searching the assembly process manual for an assembly step which corresponds to the actual component assembly step after analyzing the images recognized in the recognizing the actual component assembly step; and the visualizing the assembly process manual may include displaying the assembly process corresponding to the assembly step found from the assembly process manual in the searching the assembly process manual for the assembly step.

Here, the authoring the assembly process manual may include: producing the 3D modeling data of the plurality of components after analyzing 3D geometric information about the plurality of components; expressing a color and a material to each piece of the 3D modeling data of the plurality of components; and expressing an animation operation of authoring the assembly process manual in such a way as to include movement data for an assembly operation, in which the finished product is completed using the plurality of components, with the 3D modeling data of the plurality of components in which the color and the material are expressed in the expressing the color and the material.

Here, the expressing the color and the material may include generating a digital data value for a color in which two different colors are mixed, and applying the digital data value to the 3D modeling data of the corresponding component.

Here, the expressing the color and the material may include generating a digital data value for a material in which two different materials are mixed, and applying the digital data value to the 3D modeling data of the corresponding component.

Here, the expressing the animation operation may include: defining coupling constraints between the components based on the information about a coupling relationship between the plurality of components such that the plurality of components are coupled to each other only in one or more predetermined areas; defining a method of allowing the plurality of components to be coupled to each other along only one or more predetermined assembly points and assembly lines based on the information about the coupling relationship between the plurality of components; and defining the movement data for each stage of the assembly operation, in which the finished product is completed using the plurality of components.

Here, the expressing the animation operation may include differently expressing the adhesion portions of the respective components based on the adhesion method used between the plurality of components.

Here, the producing the 3D modeling data may include producing the 3D modeling data using at least one of a shape detection-based shape modeling method using camera images, a sketch-based shape modeling method, a template-based modeling method, and a clipart-based texture mapping method.

Here, the assembly process visualization method may further include a user selecting a specific assembly step from the assembly process manual; and the visualizing the assembly process manual includes displaying an assembly process corresponding to the specific assembly step selected by the user to the user.

Here, the visualizing the assembly process manual may include displaying the assembly process manual on an external display apparatus based on the selection of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically illustrating the configuration of an assembly process visualization apparatus according to the present invention;

FIG. 2 is a block diagram illustrating the configuration of the authoring unit of the assembly process visualization apparatus according to the present invention;

FIG. 3 is a block diagram illustrating the configuration of the visualization unit of the assembly process visualization apparatus according to the present invention;

FIG. 4 is a block diagram illustrating the new color generation unit of the assembly process visualization apparatus according to the present invention;

FIG. 5 is a block diagram illustrating the new material generation unit of the assembly process visualization apparatus according to the present invention;

FIG. 6 is a flowchart illustrating an assembly process visualization method according to the present invention;

FIG. 7 is a flowchart illustrating the assembly process manual authoring step of the assembly process visualization method according to the present invention; and

FIG. 8 is a flowchart illustrating animation action expression step of the assembly process visualization method according to the present invention.

### DESCRIPTION OF THE PREFERRED EMBODIMENTS

The present invention will be described in detail with reference to the accompanying drawings below. Here, when the description is repetitive and detailed descriptions of well-known functions or configurations would unnecessarily obscure the gist of the present invention, the detailed descriptions will be omitted. The embodiments of the present invention are provided to further completely explain to those skilled in the art the present invention. Therefore, the shapes and sizes of components in the drawings may be exaggerated to provide a more exact description.

The configuration and operation of an assembly process visualization apparatus according to the present invention will be described below.

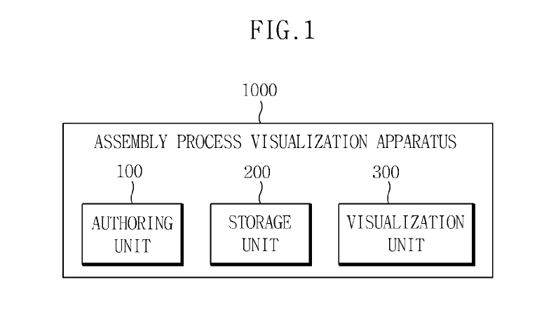

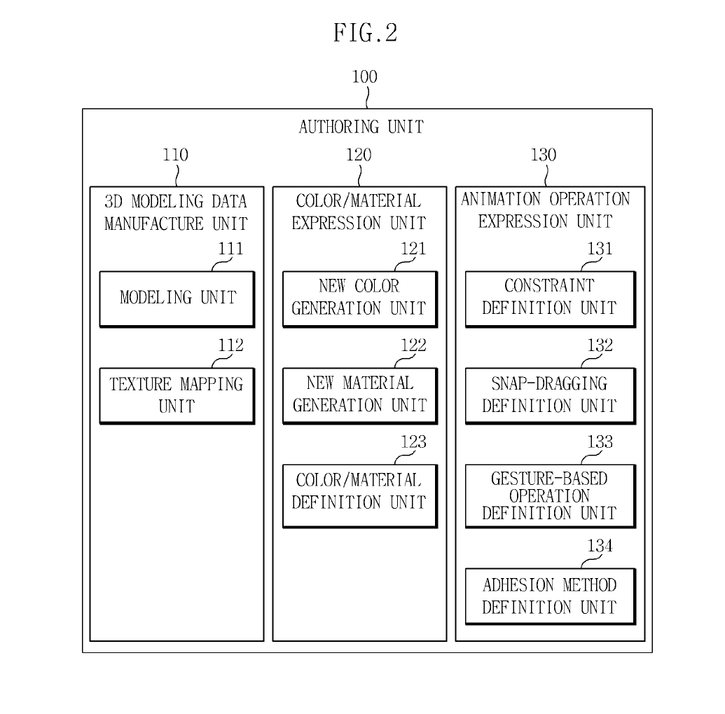

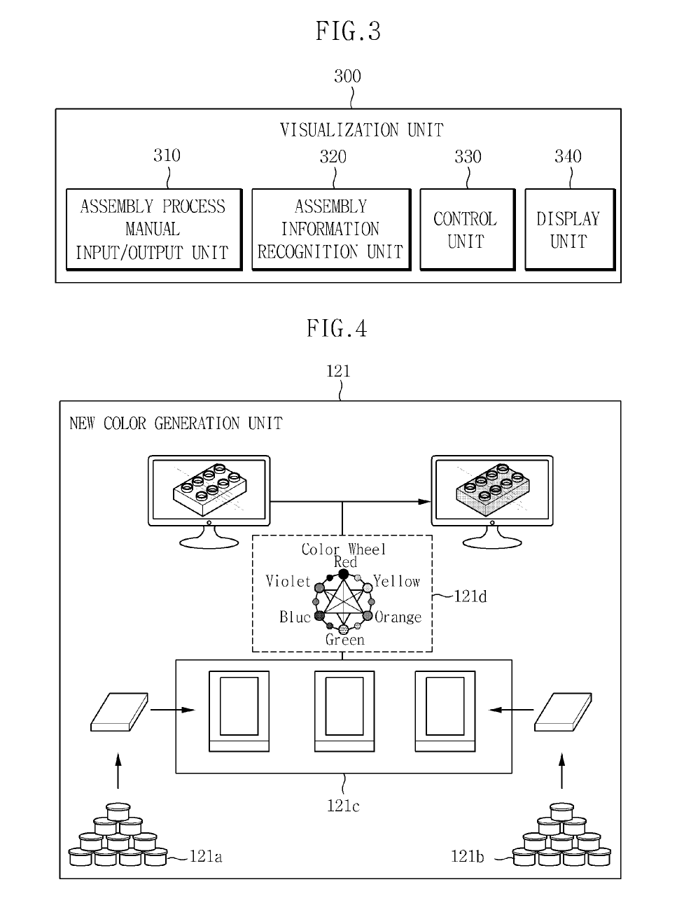

FIG. 1 is a block diagram schematically illustrating the configuration of an assembly process visualization apparatus according to the present invention. FIG. 2 is a block diagram illustrating the configuration of the authoring unit of the assembly process visualization apparatus according to the present invention. FIG. 3 is a block diagram illustrating the configuration of the visualization unit of the assembly process visualization apparatus according to the present invention.

Referring to FIG. 1, an assembly process visualization apparatus 1000 according to the present invention includes an authoring unit 100, a storage unit 200, and a visualization unit 300.

The authoring unit 100 authors an assembly process manual in such a way as to model each stage of an assembly process of assembling a plurality of components and completing a finished product using 3-Dimensional (3D) stereoscopic images.

Referring to FIG. 2, the authoring unit 100 may include a 3D modeling data manufacture unit 110, a color/material expression unit 120, and an animation operation expression unit 130.

The 3D modeling data manufacture unit 110 analyzes 3D geometric information related to a plurality of components, and manufactures 3D modeling data. Further, the 3D modeling data manufacture unit 110 may manufacture 3D modeling data using at least one of a shape detection-based shape modeling method using camera images, a sketch-based shape modeling method, a template-based modeling method in which example data which is the basis of 3D data is attached in the type of blocks, and a clipart-based texture mapping method of displaying a pattern on geometric information.

The color/material expression unit 120 expresses color and material for the 3D modeling data of the plurality of components.

The color/material expression unit 120 may include a new color generation unit 121, a new material generation unit 122, and a color/material definition unit 123.

The new color generation unit 121 generates a digital data value with respect to a color in which two different colors are mixed, and then stores the corresponding digital data value in a storage unit 200 which will be described later. The new material generation unit 122 generates a digital data value with respect to a material in which two different materials are mixed, and then stores the corresponding digital data value in the storage unit 200. The color/material definition unit 123 defines the color and material of a component based on color and material data stored in the storage unit 200. Here, the definition of the color and material of a component that is defined using the color/material definition unit 123 may be variously changed depending on selection of a user.

The animation operation expression unit 130 authors the assembly process manual in such a way as to include movement data for an assembly operation, in which a finished product is completed using a plurality of components, with the 3D modeling data of the plurality of components, in which the color and material thereof have been expressed using the color/material expression unit 120.

The animation operation expression unit 130 may include a constraint definition unit 131, a snap-dragging definition unit 132, a gesture-based operation definition unit 133, and an adhesion method definition unit 134.

The constraint definition unit 131 defines coupling constraints between components based on information about a coupling relationship between a plurality of components. That is, the constraint definition unit 131 defines constraints for the arrangement and attachment of components to other components such that the plurality of components are coupled to each other only within properly determined areas. The snap-dragging definition unit 132 allows the plurality of components to be coupled to each other along one or more predetermined assembly points or assembly lines based on the information about the coupling relationship between the plurality of components. The combination relationship between the plurality of components may be easily defined and expressed using the constraint definition unit 131 and the snap-dragging definition unit 132. The gesture-based operation definition unit 133 defines movement data for each stage of an assembly process of completing a finished product using the plurality of components. Here, the gesture-based operation definition unit 133 may include information about gestures used when a user assembles actual components for respective stages with the assembly process manual. The adhesion method definition unit 134 differently expresses the portions when the components are adhered to each other (hereinafter referred to as “adhesion portions”) based on an adhesion method used to adhere the plurality of components to each other. For example, the adhesion method definition unit 134 may differently express the adhesion portions of respective components based on a coupling method used between the components, the coupling method using glue, welding, paste, or an insertion coupling, and may apply the adhesion portions to the assembly process manual. Therefore, a user can intuitively and easily detect a method of coupling components using the assembly process manual.

The storage unit 200 receives and stores the assembly process manual authored using the authoring unit 100. Thereafter, the storage unit 200 stores color and material data to be applied to the 3D modeling data of the plurality of components. Further, the storage unit 200 may store information about new colors and new materials, which was generated using the new color generation unit 121 and the new material generation unit 122.

The visualization unit 300 visualizes each stage of the assembly process manual stored in the storage unit 200 using 3D stereoscopic images, and then displays the 3D stereoscopic images to a user.

Referring to FIG. 3, the visualization unit 300 includes an assembly process manual input/output unit 310, an assembly information recognition unit 320, a control unit 330, and a display unit 340.

The assembly process manual input/output unit 310 is formed such that a user can select the specific assembly step of the assembly process manual stored in the storage unit 200. Further, the assembly process manual input/output unit 310 may be formed such that a user can select the assembly process manual to be output to the outside.

The assembly information recognition unit 320 recognizes actual component assembly steps using camera images.

The control unit 330 performs control such that the assembly process for the specific assembly step, selected by a user using the assembly process manual input/output unit 310, is displayed on a display unit 340 which will be described later. Further, when a user selects the assembly process manual to be output to the outside using the assembly process manual input/output unit 310, the control unit 330 can control signals such that the assembly process manual is displayed on an external display apparatus, that is, a notebook computer, a tablet Personal Computer (PC), or a Television (TV). Further, the control unit 330 can perform control such that the assembly step of the assembly process manual, which corresponds to the actual component assembly step recognized using the assembly information recognition unit 320, is displayed on the display unit 340. That is, the control unit 330 can analyze images recognized using the assembly information recognition unit 320, can search for the assembly step in the assembly process manual, which corresponds to the actual component assembly step, and can perform control such that an assembly process corresponding to the assembly step of the assembly process manual is displayed on the display unit. Since the assembly information recognition unit 320 and the control unit 330 are used to visualize information about a subsequent component which will be assembled based on the actual component assembly step, a user can more rapidly understand the assembly process.

The display unit 340 displays the 3D stereoscopic images of the assembly process manual to a user. Further, the display unit 340 can guide a user through assembling components using an augmented reality method based on the operations of the assembly information recognition unit 320 and the control unit 330.

An example of the operations of the new color generation unit and new material generation unit of the assembly process visualization apparatus according to the present invention will be described below.

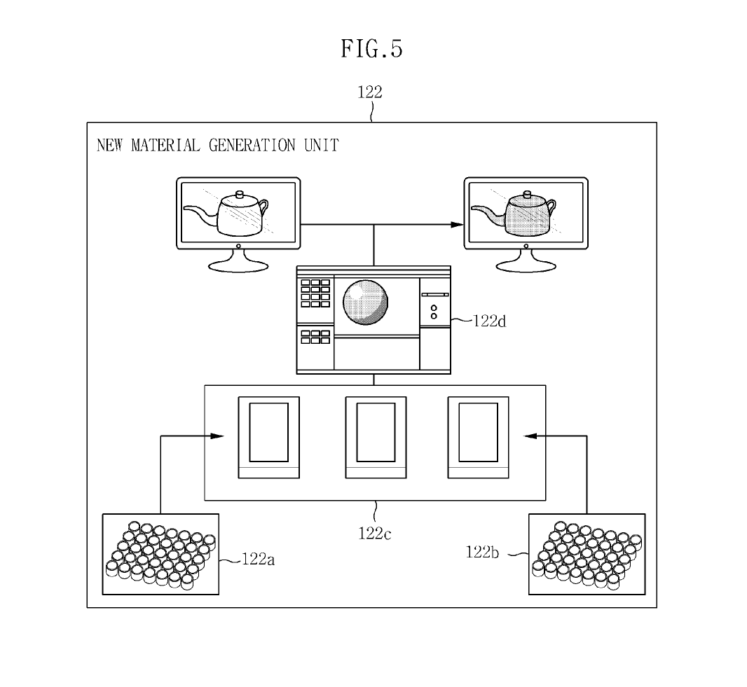

FIG. 4 is a view illustrating the new color generation unit of the assembly process visualization apparatus according to the present invention. FIG. 5 is a view illustrating the new material generation unit of the assembly process visualization apparatus according to the present invention.

Referring to FIG. 4, in the assembly process visualization apparatus according to the present invention, the new color generation unit 121 reads the color information of a first color tool 121a and the color information of a second color tool 121b using a color mixer 121c, the first color tool 121a and the second color tool 121b having two different colors, respectively. Here, the color tools may include dyes, colored clay, and cellophane paper which can represent colors. Further, a color mixer 121c can mix the color information of the first color tool 121a and the color information of the second color tool 121b, thereby generating new digital color information using a color wheel 121d. The newly generated digital color information may be applied to each component.

Referring to FIG. 5, in the assembly process visualization apparatus according to the present invention, the new material generation unit 122 reads the material information of a first material tool 122a and the material information of a second material tool 122b using a material mixer 122c, the first material tool 122a and the second material tool 122b having two different materials, respectively. Further, the material mixer 122c can mix the material information of the first material tool 122a and the material information of the second material tool 122b, and can generate new digital material information in a shader code using a material wheel 122d. The newly generated digital material information may be applied to each component.

An assembly process visualization method according to the present invention will be described below.

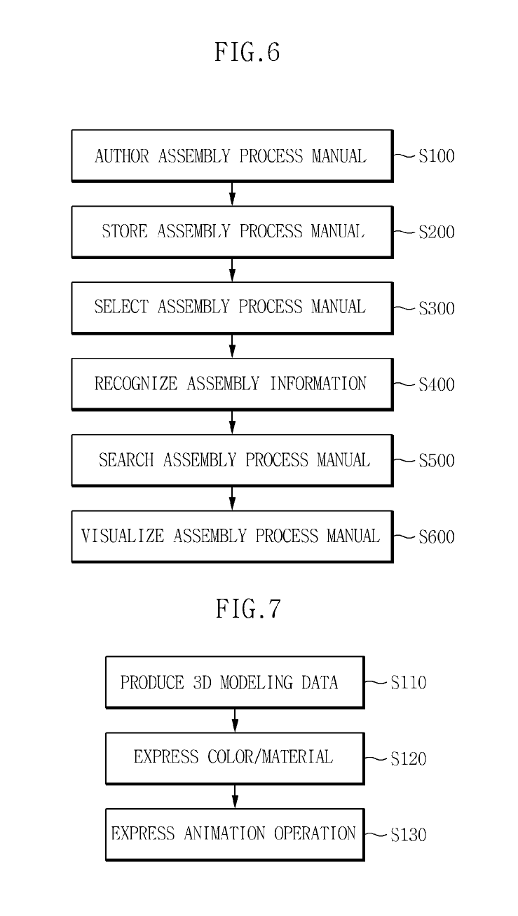

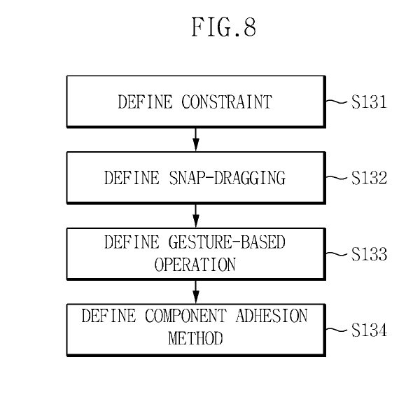

FIG. 6 is a flowchart illustrating the assembly process visualization method according to the present invention. FIG. 7 is a flowchart illustrating the assembly process manual authoring step of the assembly process visualization method according to the present invention. FIG. 8 is a flowchart illustrating animation action expression step of the assembly process visualization method according to the present invention.

Referring to FIG. 6, the assembly process visualization method according to the present invention includes an assembly process manual authoring step S100, an assembly process manual storing step S200, and an assembly process manual visualization step S600. Further, the assembly process visualization method according to the present invention may further include an assembly process manual selection step S300, an assembly information recognition step S400, and an assembly process manual searching step S500.

At the assembly process manual authoring step S100, an assembly process manual is authored in such a way that each stage of the assembly process of completing a finished product by assembling a plurality of components is modeled using 3D stereoscopic images.

The assembly process manual authoring step S100 includes a 3D modeling data production step S110, a color/material expression step S120, and an animation operation expression step S130, with reference to FIG. 7.

At the 3D modeling data production step S110, the 3D geometric information about a plurality of components is analyzed, and the 3D modeling data is manufactured. The 3D modeling data production step S110 may be realized using at least one of a shape detection-based shape modeling method using camera images, a sketch-based shape modeling method, a template-based modeling method in which example data which is the basis of 3D data is attached in the type of blocks, and a clipart-based texture mapping method of displaying a pattern on geometric information.

At the color/material expression step S120, colors and materials are expressed to the 3D modeling data of the plurality of components manufactured at the 3D modeling data production step S110.

At the animation operation expression step S130, the assembly process manual is authored in such a way as to include movement data for each assembly operation, in which a finished product is completed using a plurality of components, with the 3D modeling data of the plurality of components in which the colors and materials thereof are expressed using the color/material expression step.

The animation operation expression step S130 may include a constraint definition step S131, a snap-dragging definition step S132, a gesture-based operation definition step S133, and a component adhesion method definition step S134 with reference to FIG. 8.

At the constraint definition step S131, coupling constraints between components are defined based on the information about the coupling relationship between the plurality of components such that the plurality of components are coupled to each other only in one or more predetermined areas.

At the snap-dragging definition step S132, a method, in which the plurality of components are coupled to each other along only one or more predetermined assembly points and assembly lines, is defined based on the information about the coupling relationship between the plurality of components.

At the gesture-based operation definition step S133, movement data for each stage of assembly operation, in which a finished product is completed using the plurality of components, is defined.

At the component adhesion method definition step S134, the adhesion portions of the respective components are differently expressed based on the adhesion method used between the components.

At the assembly process manual storing step S200, the assembly process manual authored at the assembly process manual authoring step S100 is stored in the storage unit.

At the assembly process manual selection step S300, a user selects a specific assembly step from the assembly process manual.

At the assembly information recognition step S400, an actual component assembly step is recognized using camera images.

At the assembly process manual searching step S500, images recognized at the assembly information recognition step S400 are analyzed, and the assembly process manual is searched for an assembly step which corresponds to the actual component assembly step.

At the assembly process manual visualization step S600, each stage of the assembly process manual using the 3D stereoscopic images is visualized to a user. Further, at the assembly process manual visualization step S600, the assembly process corresponding to the specific assembly step, selected by a user at the assembly process manual selection step S300, may be displayed to the user. Further, at the assembly process manual visualization step S600, the assembly step, which corresponds to the actual component assembly step and is found from the assembly process manual at the assembly process manual searching step S500, can be displayed using an augmented reality method. Further, at the assembly process manual visualization step S600, the assembly process manual may be displayed on an external display apparatus depending on the selection of a user.

According to the present invention, each stage of a product assembly process is provided using 3D stereoscopic images, so that a user can intuitively and rapidly understand the assembly process. Therefore, the present invention enables the user to rapidly assemble a product.

Further, the present invention may apply colors and materials previously stored for respective components and new colors and materials, in which the previously stored various colors and materials are mixed, to an assembly process manual. Therefore, the present invention can be utilized as a tool used to increase the understanding of a user about the colors and materials.

Further, the present invention enables an actual component assembly step to be recognized using images, and enables a user to be guided through assembling a component which will be subsequently assembled. Therefore, the present invention may enable a user to easily understand an assembly process.

Further, the present invention causes the areas where components will be adhered to each other are expressed differently based on a method of coupling components, so that a user can intuitively detect the method of coupling components using an assembly process manual.

As described above, the assembly process visualization apparatus and method according to the present invention is not limited to the configuration and method of the embodiments as described above. The entirety or a portion of the embodiments may be selectively combined and configured such that the embodiments may be variously modified.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An assembly process visualization apparatus, comprising:
an authoring unit for authoring an assembly process manual in such a way as to model each stage of an assembly process of assembling a plurality of components and completing a finished product using 3-Dimensional (3D) stereoscopic images;
a storage unit for storing the assembly process manual authored using the authoring unit; and
a visualization unit for visualizing the each stage of the assembly process manual stored in the storage unit to a user.

2. The assembly process visualization apparatus as set forth in claim 1, wherein the visualization unit comprises:
an assembly information recognition unit for recognizing an actual component assembly step using images;
a display unit for displaying the assembly process manual to the user; and
a control unit for analyzing the images recognized using the assembly information recognition unit, searching the assembly process manual for an assembly step which corresponds to the actual component assembly step, and performing control such that the assembly process corresponding to the assembly step of the assembly process manual is displayed on the display unit.

3. The assembly process visualization apparatus as set forth in claim 1, wherein the visualization unit comprises:
an assembly process manual input/output unit formed such that the user can select a specific assembly step of the assembly process manual stored in the storage unit;
a display unit for displaying the assembly process manual to the user; and
a control unit for performing control such that the assembly process corresponding to the specific assembly step selected by the user using the assembly process manual input/output unit is displayed on the display unit.

4. The assembly process visualization apparatus as set forth in claim 3, wherein:
the assembly process manual input/output unit is formed such that the user can select the assembly process manual to be output to an outside; and
the control unit performs control such that the assembly process manual is displayed on an external display apparatus when the user selects the assembly process manual to be output to the outside using the assembly process manual input/output unit.

5. The assembly process visualization apparatus as set forth in claim 1, wherein the authoring unit comprises:
a 3D modeling data manufacture unit for analyzing 3D geometric information related to the plurality of components, and manufacturing 3D modeling data of the plurality of components;
a color/material expression unit for expressing one or more colors and materials to the 3D modeling data of the plurality of components; and
an animation operation expression unit for authoring the assembly process manual in such a way as to include movement data for an assembly operation, in which the finished product is completed using the plurality of components, with the 3D modeling data of the plurality of components, in which the colors and materials thereof are expressed using the color/material expression unit.

6. The assembly process visualization apparatus as set forth in claim 5, wherein:
the storage unit stores color and material data to be applied to the 3D modeling data of the plurality of components; and
the color/material expression unit comprises:
a new color generation unit for generating at least one digital data value corresponding to a color with which two different colors are mixed; and
a color/material definition unit for defining a color and a material of each of the components based on the color and material data stored in the storage unit.

7. The assembly process visualization apparatus as set forth in claim 5, wherein:
the storage unit further stores color and material data to be applied to the 3D modeling data of the plurality of components; and
the color/material expression unit comprises:
a new material generation unit for generating at least one digital data value corresponding to a material with which two different materials are mixed; and
a color/material definition unit for defining a color and a material of each of the components based on the color and material data stored in the storage unit.

8. The assembly process visualization apparatus as set forth in claim 5, wherein the animation operation expression unit comprises:
a constraint definition unit for defining one or more coupling constraints between the components based on information about a coupling relationship between the plurality of components such that the plurality of components are coupled to each other only in one or more predetermined areas;
a snap-dragging definition unit for defining a method of coupling the plurality of components to each other along one or more predetermined assembly points or assembly lines based on the information about the coupling relationship between the plurality of components; and
a gesture-based operation definition unit for defining the movement data for each stage of the assembly process of completing the finished product using the plurality of components.

9. The assembly process visualization apparatus as set forth in claim 5, wherein the animation operation expression unit comprises an adhesion method definition unit for differently expressing adhesion portions of the respective components based on an adhesion method used between the plurality of components.

10. The assembly process visualization apparatus as set forth in claim 5, wherein the 3D modeling data manufacture unit manufactures the 3D modeling data using at least one of a shape detection-based shape modeling method using camera images, a sketch-based shape modeling method, a template-based modeling method, and a clipart-based texture mapping method.

11. An assembly process visualization method, comprising:
authoring an assembly process manual in such a way as to model each stage of an assembly process of completing a finished product by assembling a plurality of components using 3D stereoscopic images;
storing the assembly process manual, authored at the authoring the assembly process manual, in a storage unit; and
visualizing the each stage of the assembly process manual stored in the storage unit to a user.

12. The assembly process visualization method as set forth in claim 11, further comprising:
recognizing an actual component assembly step using images; and
searching the assembly process manual for an assembly step which corresponds to the actual component assembly step after analyzing the images recognized in the recognizing the actual component assembly step; and
wherein the visualizing the assembly process manual comprises displaying the assembly process corresponding to the assembly step found from the assembly process manual in the searching the assembly process manual for the assembly step.

13. The assembly process visualization method as set forth in claim 11, wherein the authoring the assembly process manual comprises:
producing 3D modeling data of the plurality of components after analyzing 3D geometric information about the plurality of components;
expressing a color and a material to each piece of the 3D modeling data of the plurality of components; and
expressing an animation operation of authoring the assembly process manual in such a way as to include movement data for an assembly operation, in which the finished product is completed using the plurality of components, with the 3D modeling data of the plurality of components in which the color and the material are expressed in the expressing the color and the material.

14. The assembly process visualization method as set forth in claim 13, wherein the expressing the color and the material comprises generating a digital data value for a color in which two different colors are mixed, and applying the digital data value to the 3D modeling data of the corresponding component.

15. The assembly process visualization method as set forth in claim 13, wherein the expressing the color and the material comprises generating a digital data value for a material in which two different materials are mixed, and applying the digital data value to the 3D modeling data of the corresponding component.

16. The assembly process visualization method as set forth in claim 13, wherein the expressing the animation operation comprises:
defining coupling constraints between the components based on the information about a coupling relationship between the plurality of components such that the plurality of components are coupled to each other only in one or more predetermined areas;
defining a method of allowing the plurality of components to be coupled to each other along only one or more predetermined assembly points and assembly lines based on the information about the coupling relationship between the plurality of components; and
defining the movement data for each stage of the assembly operation, in which the finished product is completed using the plurality of components.

17. The assembly process visualization method as set forth in claim 13, wherein the expressing the animation operation comprises differently expressing adhesion portions of the respective components based on the adhesion method used between the plurality of components.

18. The assembly process visualization method as set forth in claim 13, wherein the producing the 3D modeling data comprises producing the 3D modeling data using at least one of a shape detection-based shape modeling method using camera images, a sketch-based shape modeling method, a template-based modeling method, and a clipart-based texture mapping method.

19. The assembly process visualization method as set forth in claim 11, further comprises a user selecting a specific assembly step from the assembly process manual,
wherein the visualizing the assembly process manual comprises displaying an assembly process corresponding to the specific assembly step selected by the user to the user.

20. The assembly process visualization method as set forth in claim 11, wherein the visualizing the assembly process manual comprises displaying the assembly process manual on an external display apparatus based on selection of the user.
